(19) United States
(12) Patent Application Publication
(10) Pub. No.: US 2014/0279682 A1
(43) Pub. Date: Sep. 18, 2014

(54) SYSTEM AND METHOD FOR MANAGING CROWDFUNDING PLATFORM INFORMATION

(71) Applicant: Aleksandr Feldman, Brooklyn, NY (US)

(72) Inventor: Aleksandr Feldman, Brooklyn, NY (US)

(21) Appl. No.: 13/831,559

(22) Filed: Mar. 14, 2013

(51) Int. Cl. G06Q 40/06

(52) U.S. Cl. CPC G06Q 40/06
USPC 705/36 R

(57) ABSTRACT

A system and method of collection, management and provision of information relating to various types of investment platforms is disclosed. In one aspect, the system provides a useful way for users to search, filter, compare, and display information relating to investment platforms. In another aspect, the system collects information relating to the user and their proposed venture. In another aspect, the system matches ventures with investment platforms. The system is also capable of matching users with investment ventures. The system also provides a comprehensive information database relating to investment platforms. In another aspect, the system connects users with professional services based on the users' activities and industries. In another aspect, the system validates users and investment opportunities for certain criteria to ensure integrity and trustworthiness of the system.

### FIELD OF INVENTION

This invention relates to the collection, management and provision of information relating to various types of investment platforms.

### BACKGROUND

Entrepreneurs and startup companies are frequently the lifeblood of a modern economy because they produce, research, and develop new ideas and technologies. New businesses and technologies, however, frequently require significant amounts of capital, either to start up or expand the business. Traditionally, entrepreneurs have relied on a network of business connections to obtain access to capital. Different types of investors exist in today's world.

The initial investment is usually provided by family and friends. For more commercial investments, startups usually look for angel investors, venture capital firms, commercial banks, and investment banks. Angel investors frequently provide what is known as “seed funding,” or initial startup expenses to get the company moving forward. While there is no hard and fast rule, angel investors typically provide less than $500,000 in funding. Venture capital firms and investment banks can provide substantially greater investments, but they typically finance more developed companies who are seeking to expand their reach. Commercial banks also provide funding in a form of loans, but loans are difficult for startup companies to obtain due to the commercially uncertain nature of the startup enterprise. In recent years, however, a promising new form of investment method has emerged called “crowdfunding.”

One aspect of crowdfunding is the ability to tap into a large number of potential investors for smaller amounts of money per investor, as opposed to the conventional approach of having few investors with comparatively large capital outlays. Recently, the United States Securities and Exchange Commission has approved crowdfunding as a form of investment where unaccredited investors can own shares in private companies, ushering in a new age of crowdfunding investment for startup companies and entrepreneurs.

A crowdfunding platform is usually a website designed to bring entrepreneurs, startup companies, and individuals seeking funding together with investors. The crowdfunding process typically works as follows. An entrepreneur joins a crowdfunding platform, such as Kickstarter, by following an online signup process and providing the requested login information, such as their name, email address and password. The entrepreneur is then given the option to start their own crowdfunding project, by providing some descriptive information about the project, including a title, project location, a description of the project, funding duration, and the amount of money desired to be raised. The project is then posted on the crowdfunding website for public viewing, and is accessible through a search option on the website. Potential investors and project financiers may review the project, contact the entrepreneur, and fund the project should they so desire.

A number of crowdfunding websites exist today, including Kickstarter, Causes, Prosper, and many others. They offer a number of different features to startups and entrepreneurs, including different kinds of investments, such as, for example, equity, debt, donation, and reward. The amount of options and variations presented by the different platforms to entrepreneurs seeking funding can be overwhelming, and unhelpful.

For an average entrepreneur, faced with a multitude of crowdfunding platforms, the choice of which platform to use can be daunting. Further, if a startup chooses a crowdfunding platform that does not meet its needs, or provides funding in a suboptimal or inadequate manner, the end result for the startup can be disastrous. Not only did the startup waste precious time by sitting through a round of crowdfunding that did not meet the startup's goals, but a failed fundraising round may tarnish a startup's reputation and future prospects. It is therefore very important for entrepreneurs and startups to correctly choose their crowdfunding platform.

A need therefore exists to provide an accessible and useful system for collecting, managing, sharing, and providing information relating to various investment platforms, investment ventures, and players in the industry. This need is met by the presently disclosed invention, developed by CrowdsUnite, Inc. (www.crowdsunite.com).

### SUMMARY

In one embodiment of the present invention, the system and method facilitate the matching of proposed investment ventures with investment or crowdfunding platforms. A user interacts with the system via a web interface. If the user is not registered, the system registers the user, and collects investor credentials where appropriate. The system then allows a registered user to create a profile for an investment venture, such as a project or company. The profile is stored on a database server. One goal of the system is to help and guide entrepreneurs to successfully raise money using the crowds. In one embodiment, the system may advertise services pertinent to the user's venture after the venture profile is creates. The system may attempt to match the venture with one or more investment or crowdfunding platforms based on a set of parameters. In another embodiment, the system offers additional services pertinent to the user's venture. The system may offer the user the option of transmitting the venture profile to one or more investment or crowdfunding platforms. Further, the system may keep track of the status of the venture with respect to the submitted platforms, and may update the user accordingly. In another embodiment, the system may perform financial valuation of a proposed venture based on provided parameters.

In another embodiment, the disclosed system and method maintain information regarding investors and/or ventures. The system may store credentials and other information, such as net worth and data about individuals' current investments, in order to help investors comply with applicable regulations. The system may also store data relating to ventures, to keep the venture owners updated as to the venture's status, and also to allow outside investors to check credentials of the venture and its owners, as part of the investors' due diligence process. The system may also store information about various investment or crowdfunding platforms, including monthly traffic, funded ventures, and requirements, to provide credibility to the specific platforms. Based on stored or obtained information, the system may validate the identity and nature of investors, ventures, and platforms to prospective clients and business partners.

In another embodiment, the disclosed system and method provides information regarding various investment or crowdfunding platforms. In one embodiment, the system obtains and/or refreshes information regarding various investment platforms automatically, by connecting to platform servers via the Internet and requesting updates as to various aspects of the investment platforms. The system may allow users to search and filter by various parameters applicable to investment platforms, and to request detailed information about the platforms.

### BRIEF DESCRIPTION OF THE DRAWINGS

FIG. 1 is a flow chart illustrating the steps of registering a user with an investment platform.

FIG. 2 is a flow chart illustrating the steps for registering a project with an investment platform.

FIGS. 3A-3C illustrate various embodiments of computer servers capable of supporting the disclosed system and method. FIG. 3A illustrates an embodiment comprising a single computer server. FIG. 3B illustrates an embodiment comprising three computer servers, including a web server, an application server, and a database server. FIG. 3C illustrates an embodiment comprising a server farm with multiple servers.

FIG. 4 illustrates one embodiment of user profiles stored in a database.

FIG. 5A illustrates an embodiment of investor profile information stored separately from the user profile.

FIG. 5B illustrates an embodiment of user information stored in the same profile as investor information.

FIG. 6 illustrates one embodiment of a venture profile stored in a database.

FIG. 7 illustrates one embodiment of an investment platform profile stored in a database.

FIG. 8 is a flow chart illustrating one embodiment of the disclosed system and method.

FIG. 9A is a flow chart illustrating one embodiment of the system's service offerings.

FIG. 9B is a flow chart illustrating another embodiment of the system's service offerings.

FIG. 10 is a flow chart illustrating one embodiment of the match engine.

FIG. 11 illustrates one example of a webpage generated by the disclosed system and method.

### DETAILED DESCRIPTION

Generally, crowdfunding platforms have two types of users: individuals interested in investing in a particular project or company, and individuals interested in posting a project or company to attract investment. Sometimes the same user may be both an investor and an entrepreneur. In order to function, crowdfunding platforms typically require users to register, by providing certain basic information about themselves. This process is illustrated in FIG. 1.

FIG. 1 shows a flowchart of a basic registration process with a crowdfunding platform. The user may be asked to enter his or her name in step 10, e-mail address in step 11, password in step 12, country of residence in step 13, phone number in step 14, and mailing address in step 15. Naturally, the sequence of the registration steps need not follow FIG. 1 precisely. The registration form may also request other information, such as annual income or other identifying information, such as a social security number.

Once registered, a user may post a project or company seeking an investment. The crowdfunding platform may request information as illustrated in FIG. 2. For example, the user may be asked to provide a company name 20, contact information 21, project title 22, a brief description 23, detailed description 24, upload drawings 25, select a fundraising type 26, and enter a desired amount to be raised 27. Based on the entered information, the crowdfunding platform will create an entry for the company on its website, and make it publicly available to investors.

Turning to the present invention, in the preferred embodiment, the system described herein is a web-accessible platform, comprising one or more servers that collect, manage, provide crowdfunding and investment information, and/or facilitate matching of investors with crowdfunding and investment platforms, startup projects and companies. The system is designed to handle the specifics of crowdfunding, and to provide the end user with useful analysis and access to such services.

### System Architecture

### Servers

The system described herein can be implemented using software running on one or more computer servers. The servers may offer functionality typically found in web servers, database servers, and application servers. As commonly understood in the art, web servers act as the interface that permits end users to access applications and/or data found on the server system through a website. Database servers typically provide access to data stored on a server, and also allow for input and/or processing of that data. Application servers commonly facilitate the processing of data and the execution of applications available on the server system. As an example, in one embodiment, the processing steps 842 (FIG. 9A), 872 (FIG. 9B), 851 (FIG. 10), and 858 (FIG. 10) are performed by application servers. In another embodiment, those same processing steps may be performed by database, or other computer servers.

One of ordinary skill in the art will understand that the terms “server”, “web server”, “application server”, and “database server” refer more to the functional aspects offered by components of the system than to physical separation of the underlying computer hardware. Indeed, in one embodiment, the entire system may be implemented on a single server running all of the software components required to implement the disclosed system. In other embodiments, the disclosed system may run “in the cloud”, or put differently, on a distributed server network.

Several embodiments of the server architecture are illustrated in FIG. 3. FIG. 3A shows the disclosed system implemented on a single server 30. FIG. 3B shows an embodiment where the system is implemented on web server 32, application server 34, and database server 36. FIG. 3C shows a possible implementation using racks of servers 38, comprising an entire server farm 39. As noted above, many different combinations of servers and applicable architectures are possible.

### Online System

In the preferred embodiment, the disclosed system is accessible via the Internet to potential end users, including entrepreneurs, startup companies, and investors. As disclosed further, however, in some embodiments the system also features additional connectivity to crowdfunding platforms and other databases. In certain other embodiments, described below, this system can also be implemented on a closed network, such as a private LAN.

### Database

The disclosed system includes a database, the architecture of which is described in further detail below. The database can be implemented using various technologies, including, for example, SQL based products such as MySQL and Microsoft SQL, as well as other database products such as Oracle, IBM DB2, and Sybase. In certain embodiments, the disclosed system does not require all of the features present in comprehensive database solutions, and may even be implemented using some of the database functionality present in online services like WordPress.

### Database Architecture

The database is configured to store information relating to the system's end users, including investors, projects and companies seeking investment, and crowdfunding platforms. In certain embodiments, the database may be configured to store only a subset of the above information.

### User Profiles

One category of stored information relates to the registered users of the disclosed system. While certain crowdfunding information can be made available on the public portion of the website, individuals wishing to have greater access to the system's features, such as, for example, profile matching, can be required to register and provide certain information. User registration may be conducted via a website, which requests users to enter their name, e-mail address, phone number, mailing address, country of residence, other contact information, login information, user id, and other information.

One embodiment of a database object for a user profile is illustrated in FIG. 4. The database is hosted on server 40, which can be one or more computers. The database comprises a collection of user profiles 42, arranged and stored in accordance with the approach employed by the database technology and its administrator. FIG. 4 also expands on UserProfile_{—}3, a record in the user profile database, shown as item 44 in the figure. User profile 44 contains a number of identifying and contact information fields, a number of which may be optional.

### Investor Profiles

In another embodiment, the system may create additional records for users who are potential or current investors. Users may be required to specify whether they are an investor upon registration. If the user answers ‘yes’, the system may then prompt the user to enter additional information, such as their annual income, current and past investments, and their net worth, including liquid assets.

These records may be stored in a separate database portion, or they may be appended to the user profiles described above. In other embodiments, the database may create separate records for users who choose to be identified as investors than those who do not so choose. Two of these embodiments are illustrated in FIG. 5. FIG. 5A shows a database that has two separate entries for user profiles and for investor profiles. Basic user information is stored in user profiles 50, whereas information relating to investor credentials is stored in investor profiles 52. In the illustrated embodiment, an investor profile may contain a user id number, the investor's annual salary, his or her net worth, the amount of liquid assets possessed, total current investments, and descriptions and data relating to their current and previous investments. FIG. 5B illustrates an embodiment where investor and user profiles are combined into a single table 56. One of ordinary skill in the art will understand that other database schema are possible for storing user and investor profiles.

Other information may be stored in relation to the user and investor. For example, the database may store social security numbers or other identifying information, their credit scores, credit histories, and a history of prior investment attempts.

### Venture Profiles

The database can also be configured to store profiles of projects or companies seeking investments, also referred to as ventures herein. In the preferred embodiment, the system offers registered users an opportunity to enter information relating to a venture for which they seek investment or funding. One embodiment of a database entry for a venture profile is illustrated in FIG. 6.

In FIG. 6, venture profile 600 comprises a number of different fields, many of which are optional depending on the embodiments. As will be understood by one of ordinary skill in the art, some of the fields may contain text, numerical entries, or may even be data objects themselves, capable of containing multiple sub-fields (such as fields 605, 611, and 617) or other data objects. Some of the potential fields in venture profile 600 include the venture id number 601, venture name 602, company name 603, geographic location 604, mailing address 606, e-mail address 607, phone number 608, website 609, other contact information 610, venture leadership 612, previous investments 613, available references 614, presentations 615, and preliminary research 616. Field 605, venture description, contains several sub-fields, such as venture summary 618, detailed description 619, and drawings/figures/data 620. Elements 618-620 are used to describe the venture in some detail. Investment Type Sought field 611 allows ventures to describe the types of investment sought, by entering investment type 621, investment amount 622, term 623, and conditions 624. Current finances field 617 is used to provide current financial information for the venture, including profit/loss 625, balance sheet 626, outstanding shares 627, and current obligations 628.

### Platform Profiles

One of the features of the disclosed system is the ability to maintain information about numerous crowdfunding and investment platforms. In the preferred embodiment, that information is stored in a database in the form of a profile for each platform. Different crowdfunding platforms serve different markets, and in fact can offer different services. The system described herein is flexible enough to account for, and take advantage of, these different features and capabilities. The following is a description of certain platform attributes that can be stored in the database together with, or as part of, the platform profiles. FIG. 7 illustrates one embodiment of a crowdfunding platform profile. Platform profile 700 contains data relating to a crowdfunding platform, the platform being identified by Platform ID Number 701.

### Locations

Crowdfunding, like other investment activities, may implicate government regulation, such as securities and trading laws. These laws and regulations usually apply within the borders of a specific country or territory, and may differ from one location to another. Further, in certain geographic regions, lending or investing may carry religious or ethnic restrictions, such as the case with Islamic finance. Crowdfunding platforms can also be capable of selection based on their geographic location.

The database can be configured to store several types of location information relating to crowdfunding platforms. For example, as shown in FIG. 7, Location Information field 702 is a data object that has several sub-fields, such as the Countries of Requestor 718, Countries of Investor 719, and Other Location Data 720. Countries of Requestor field 718 lists the countries from which the crowdfunding platform will accept venture submissions. Some platforms only accept venture submissions from a limited number of countries. Similarly, Countries of Investor field 719 lists the countries from which the crowdfunding platform will accept investments for the listed ventures. Other Location Data field 720 may be used to store additional location data, such as, for example, regional requirements for investors and ventures, or data regarding regional authorities.

### Investment Type

Typically, a company must give something in return for capital, and this is no different in a crowdfunding situation. Some crowdfunding platforms offer the ability for startups to take out loans, also known as debt. In a “debt” funding round, the startup collects funds from a number of lenders through a crowdfunding platform, and promises to pay back its debt at a certain interest rate and in due time. Other platforms allow startups to offer “equity.” In an equity crowdfunding round, the startup will offer a certain percentage of the company to investors, and assuming the round concludes successfully, the investors will become part owners in the startup. Yet certain startup companies may not be of a commercial nature, and they may be seeking “donations,” rather than loans or equity investments, from crowdfunding users. More recently, certain startup companies and projects have started to offer “rewards” to investors. These rewards may come in the form of a discount for their products, whenever the product is completed and available for sale,” or they may come in the form of early shipping, to name another example.

In FIG. 7, field 703 corresponds to the Investment Type. Certain crowdfunding platforms offer multiple types of investments, such as equity and debt, and therefore field 703 may contain multiple entries.

### Categories

The database can be configured to store categories of ventures supported by crowdfunding platforms. Certain platforms do not permit the listing of companies, whereas others limit their offerings to artistic projects. Further, in the technology fields, some platforms do not permit software development projects. To help match platforms to specific ventures, the platform profile 700 illustrated in FIG. 7 can include a Category field 704. The Category field may include multiple entries, including broad categories (such as “businesses” and “projects”) or may be focused on technical areas (such as “software”, “semiconductor”, and “telecommunications”). Categories may also include donations, educational fundraising, and personal loans, among others.

### Fees

Platform profile 700 may include a Fees field 706 corresponding to the fees charged by the crowdfunding platform. In one embodiment, fields 721, 722, and 723 account for the various possible fee types. For example, some platforms charge a fee for a completed campaign, and this is indicated in field 721. Other platforms also charge a fee for a partially completed campaign, indicated in field 722. Some platforms charge a fee for every transaction, such as a listing. Platforms that accept credit card transactions may charge a fee to cover the cost of credit card processing. These fees can be recorded in field 723.

### Campaign Type

Platform profile 700 may include field 707 relating to the types of investment campaigns offered by the platforms. For example, certain crowdfunding platforms offer “all or nothing” campaigns, where if the desired amount is not raised, the entire campaign is terminated and the money is returned to the investors. Other platforms offer “keep what you raised” campaigns, where the venture gets to keep whatever money was raised even if the total goal was not reached. Some platforms offer both campaign types, and this can be reflected in field 707.

Platform profile 700 contains other fields that can be used to identify different attributes of crowdfunding platforms. For example, Monthly Visitors 705 can provide the number of monthly visitors, which indicates the popularity and stability of a platform. Requestor Type field 708 may be used to specify whether the platform allows submissions from companies, non-profit organizations, individuals, or some other type/combination of requestors. Platform Tags field 709 is used to store tags applicable to the platform. The tags may then be displayed on the website to help users navigate specific platform attributes. Platform Reviews field 710 is used to store user and critic generated reviews of the crowdfunding platform. Platform Comments field 711 is used to store comments relating to the platform generated by users and administrators of the disclosed system.

As an advertising feature, and also as a way to provide users with a preview of the platform, field 712 in platform profile 700 is used to store one or more screenshots of the various screens displayed by the crowdfunding platform. Field 713 is used to store articles concerning the platform, such as those appearing in a newspaper or website. Field 714 contains a URL to the platform for which platform profile 700 is being maintained. Field 715 may contain multiple sub-fields such as Ventures Funded field 724, Ventures Rejected field 725, Amounts Raised field 726, and Ventures Listed field 727. Ventures Funded field 724 may contain the number of funded ventures, including some information about those ventures. Ventures Rejected field 725 may contain the number of rejected ventures, and other information, such as the amounts they sought to raise. Amounts Raised field 726 may contain financial numbers with respect to the amounts raised by ventures posted on the platform, such as the high, low, medium, average, and total amounts raised. Ventures Listed field 727 may identify the total number of ventures that were listed on the platform, or the number of ventures listed during the calendar year.

It will be understood by one of ordinary skill in the art that multiple implementations of database functionality are possible. Items referred to herein as “fields” may be pointers to memory locations where the data is stored. Fields may also be data objects capable of storing one or multiple pieces of information. The attributes identified above may themselves be stored as a text string, integer, float, other field, or even as a data object. The above discussion of the database configuration is not meant to limit the possible embodiments of the database.

### Functions and Services

As noted above, the system comprises one or more servers connected by a computer network, configured to perform certain functions and offer services. Some of the system's services are offered through a website interface made available on the web through a web server. Other services, and certain underlying functions, are not visible to the end user, and run on the server network. FIG. 8 illustrates a flowchart of functions offered by the system.

At step 800, the end user accesses a website hosted on one of the system's web servers. The website may also be hosted by a third party provider. At step 810, the system determines whether the end user is registered to use the system or not. If the user is registered, the system skips registration step 814 and proceeds to step 820. If the user is not registered, the system, through its website, presents the user with a registration screen and collects the required user information at step 814.

To collect registration information from a user, the system presents the user with a webpage containing text and numerical fields for the user to fill in. Information provided by the user is then stored a user profile in the system's database. One example of a user profile is illustrated in FIG. 4, which shows a database entry containing a name, e-mail address, phone number, mailing address, country of residence, user id, password, and possibly other contact and identifying information, such as a social security number. It will be understood that the user profiles may have a different structure and may contain different information.

As noted above, the system may be configured to inquire whether a user is an investor, and if it so determines, the user may be prompted to enter additional information, which can be helpful in establishing the user's investor credentials. As illustrated in FIGS. 5A and 5B, the investor profile may contain the investor's annual salary, net worth, liquid assets, total current investments and investment descriptions. After the user enters this information, the investor profile is stored in the database.

Once registration is complete, the system proceeds to step 820, where the system determines whether the user is interested in pursuing investment opportunities, or seeking investment for his or her venture. This determination can be made in several ways. The system may access the user's profile to see if there is a record indicating that the user is an investor. Further, the system may check the user's profile to see the user's activity history, and if the user has predominantly participated on the website as an investor, the system can decide that he or she should be so treated during the current session. In addition, the user may indicate his or her own preference by making a selection on the website.

If the system determines that investment opportunities should be presented, the website may let the user browse the various crowdfunding platforms and/or projects stored in the system's database. The system may also let the user search for fitting investment opportunities. This choice is presented to the user at step 880. If the user chooses to browse available opportunities, the system proceeds to step 888, where the website displays available platforms and opportunities to the user. If, at step 880, the user chooses to search the database, the system executes the search engine at step 884, before producing the search results at step 888. It will be understood by those of ordinary skill in the art that the end user may be presented with a webpage that allows browsing, as well as searching and/or filtering of the crowdfunding database. In other words, the user does not have to be restricted to either browsing or searching. Such an embodiment is illustrated in FIG. 11.

If the user decides to search or filter through the various crowdfunding platforms, the web server will transmit the user-selected parameters (such as a platform name or type of investment sought) to the back-end application or database servers. These servers will use the provided parameters to find corresponding crowdfunding platforms based on the stored platform profiles, such as the one illustrated in FIG. 7. In one embodiment, the user is able to search through every field appearing in the platform profiles. However, in other embodiments, the system administrator may limit the search feature to several fields, or restrict certain fields from being searched. For example, the administrator may restrict the searching of Articles and Reviews fields because the searches may deliver too many hits, making the search function less usable. Other fields may be restricted for security reasons, or to protect certain confidential information about a platform.

Once the servers have found crowdfunding profiles and fields that correspond to a user's search string or other provided information (such as the user's configuration of a filter on the website), the system packages the search results into a collection of user-viewable data, preferably transmitted to the user in the form of a webpage (or a set of data that will be displayed in a webpage). In one embodiment, the system generates a webpage that lists search results in the form of text strings, highlighting the text that matches the user-provided text string. In another embodiment, the system generates a webpage that lists the corresponding crowdfunding platforms without making any references to the user's search or filter selections.

Turning back to step 820, if the system determines that the user should be allowed to enter data regarding his or her venture for which investment is being sought, the system proceeds to step 830, where the website collects the required venture data.

At step 840, after initially processing the received venture data, the website presents the user with service offers, described in more detail below. The system then proceeds to step 850, where it executes the match engine designed to match the user's venture with corresponding crowdfunding platforms. The match engine is described in greater detail below. The system then moves to step 860, where it pushes the venture data to crowdfunding platforms selected by the user. After pushing the venture data, the website offers additional services to the user at step 870, and concludes the process at step 890. Steps 840, 850, 860, 870, and the underlying computer processes, are described in detail below.

### Services

One aspect of the present system is the ability to advertise appropriate services to end users as they navigate the system's website. In FIG. 8, service offerings are identified as steps 840 and 870. In the preferred embodiment, service offerings 840 and 870 are tailored to meet the needs of an entrepreneur looking to crowdfund his or her venture using the system's website. In order to properly tailor service offerings to a user's venture, the system must analyze the type of venture, its characteristics, as well the stage of the venture's development. One embodiment of these processes are illustrated in FIGS. 9A and 9B.

In FIG. 9A, the process begins with step 840, Begin Offer Services Routine, which occurred after the user entered data describing the venture. Armed with the “venture data,” the system is capable of analyzing the venture and determining which services may interest the user. In step 842, the system processes received venture data. In one embodiment, the system focuses on data relevant to service offers, such as Venture Description field 605 and Phone Number field 608 (illustrated in FIG. 6), and ignores other parameters, such as Available References field 614 (also illustrated in FIG. 6). Thus, for example, the system may determine that the venture is a startup company, which could indicate that the end user is interested in receiving offers for accounting services, tailored to a location based on the phone number.

If, however, the venture is a product development project, the end user may be less interested in accounting services. In this scenario, the system may advertise video creation and marketing services, which help the user raise the desired funds. The user is presented with several choices of video creation and marketing companies. The user may select one or more of the advertised services, and if done through the system website, the system will transmit information relating to the user and his or her project to the marketing companies. The companies will then work to create a video advertisement, and other marketing materials for the project, and the user may place the resulting video and materials in the description of his or her project on a crowdfunding platform. In another embodiment, the user may store the marketing materials as part of the venture profile created by the user and stored by the disclosed system.

In step 844, the system compares the processed venture data with a databank of preliminary services residing on one or more database servers. Based on the information gleaned from the processed venture data, the system determines which services would be appropriate to advertise to the end user in step 846. In one embodiment, the system will recognize that the current service offerings are taking place before the venture has started a funding campaign, and may offer marketing services to the end user to help him or her create a more attractive and more effective funding campaign. Once appropriate services have been selected, they are presented to the user via the website in step 848. In step 850, the system returns to the flowchart illustrated in FIG. 8 and executes the Match Engine described in further detail below.

In the preferred embodiment, the next time services are offered to the end user after the venture profile is pushed to crowdfunding platforms in step 860. In step 870, the system again offers services to the user, as illustrated in FIG. 9B. The flow of process steps in FIG. 9B is similar to that of FIG. 9A. In step 872, the system processes the venture data pushed to crowdfunding platforms in step 860. In step 874, the system compares the processed venture data with the databank of available services. In step 876, the system compares the processed venture data with services available for the specific platforms the data has been pushed to. In step 878, the system determines appropriate services to be offered to the end user, and in step 879, the system presents the services to the user via the website. The process concludes in step 840.

It will be understood by those of ordinary skill in the art that the services illustrated as steps 840 and 870 in FIG. 8 can be offered at various times to the user. For example, services may be offered to the user before he or she registers with the website, in the form of financial advisory or related services. Services may also be offered simultaneously with project and venture registration screens, in the form of services that assist users to properly fill out venture profiles. Similarly, other services may be offered in connection with the matching process. Moreover, services may be offered to users as they browse or search for different crowdfunding platforms.

In the preferred embodiment, the system attempts to identify appropriate services based on the user's browsing, search, and/or registration behavior. For example, when a user creates a venture profile for a startup company, the system will analyze the profile for the various text strings entered by the user, as well as categories selected by the user. This can be done by parsing fields illustrated in FIG. 6 such as Venture Description 605, Venture Summary 618, Detailed Description 619. And Drawings/Figures/Data 620. The system may index these fields as part of its search algorithm. As one example, after parsing the fields, the system may determine that the startup company will develop tax software (for example, based on the frequency of occurrences for ‘tax’ and ‘software’, or the selected categories). Based on this determination, the system may advertise accounting services based on the presence of ‘tax’ in the venture profile, and software development and patent attorney services based on the presence of ‘software’ in the venture profile. It will be understood that different services may be presented to the user, including accounting, financial services, software development, recruiting, legal, marketing, website design, real estate, manufacturing, engineering, and environmental services.

In certain configurations, the system may also provide an educational service to the user through its website. Thus, for example, the website may provide a guide for every step of the searching, or crowdfunding process, to help entrepreneurs and other website users to get the most out of their experience with the system and make the right decisions. The educational services may be presented in the form of pop-up help windows, presentations, chat boxes, videos, or other visually appealing and explanatory features.

### Match Engine

Generally speaking, the Match Engine is used to find crowdfunding platforms that will match the parameters of a venture profile created by an end user. The goal of the Match Engine is to enable a user to find the best crowdfunding platforms for his or her venture. One embodiment of the Match Engine is illustrated in FIG. 10.

In the preferred embodiment, the Match Engine is executed after the user enters data for his or her venture. In step 851, the system processes received venture data. In one embodiment, the processing step 851 may include the creation of a data object comprising information that will be transmitted to the crowdfunding platforms. In another embodiment, the processing step 851 may involve analyzing the venture and its parameters, including providing a valuation of the venture as described below, optimizing various debt scenarios, and analyzing its social media indicators. In step 852, the system accesses the matching database, which contains records pertaining to crowdfunding platforms that accept submissions of venture profiles over the Internet or other computer networks. In step 853, the system queries the matching database based on parameters found in the venture profile created by the user. The system may query for platforms by geographic location 854, the investment type sought 855, current finances 856, or other parameters 857 determined to be required in step 851 or elsewhere.

The purpose of the query and processing steps is to find the most appropriate crowdfunding platforms for the proposed venture. Thus, in the preferred embodiment, the system will consider the amount of investment sought by the venture, and will compare that amount with amounts financed by various platforms in the past. The system may then exclude platforms that have historically financed smaller amounts than that requested by the venture. In the preferred embodiment, the system will also filter platforms by location and type of venture, taking into account whether the venture is a design project or a startup company, for example. Other matching criteria may include project categories and industries. In the preferred embodiment, the system is able to correctly handle several campaign types in a single venture profile. Thus, for example, a user may enter both an “equity” and a “debt” investment type in his or her venture's profile. In this example, when matching the profile with the available platforms, the system will be able to return platforms capable of handling equity funding, platforms capable of handling debt funding, and platforms capable of both.

Once the database server returns results of the query, the system processes the results in step 858 for presentation to the user at step 859. At step 859, the website presents the user with a list of crowdfunding platforms determined to be a good fit for the proposed venture. The user may then be presented with an option to submit the venture profile to one or more of the platforms at step 860.

### Venture Data Push

In step 860, the system's website presents the user with an opportunity to transmit (or “push”) the venture profile to one or more crowdfunding platforms. In the preferred embodiment, the system will prompt the user whether he or she would like to send the profile to the platforms selected by the Match Engine, or whether he or she would like to manually select the platforms for submission.

Once the platforms have been selected, the system generates a data object in the format preferred by each of the selected platforms, containing information derived from the venture profile created by the user. The information in the data object is arranged in the fashion preferred by the selected platforms, but the data is pulled from the venture profile. Next the system transmits the data objects to the selected platforms via a computer telecommunications network. In some instances, the platforms will have a public interface designed to accept incoming venture profiles. In other instances, the platforms will be less cooperative, and the system will execute a macro to enter the venture profile into text fields and boxes provided by the platform website. In the preferred embodiment, the disclosed system will be configured to automatically determine the best approach to transmitting the venture data objects to the crowdfunding platforms.

After transmitting (or “pushing”) the venture profile to investment platforms, the system maintains records on its database server relating to the status of the venture. In the preferred embodiment, the database contains records relating to the status of the profile push (i.e. whether the transmission was successful or not), whether the system received an acknowledgement from the investment platforms, and what the current status of the venture is with the various platforms (such as “accepted,” “rejected,” “unfunded,” “partially funded,” and “fully funded.”). In addition the venture database may include updates regarding the amounts raised by the venture at various platforms. The venture database may be periodically refreshed by the disclosed system by accessing the crowdfunding platforms to which the venture was submitted, or the database may be updated by the platforms themselves, by transmitting a status update to the presently disclosed system.

Following a successful submission of their venture to various funding platforms, the entrepreneur may wish to update the platforms, and most importantly his or her investors, about the status of the venture. To this end, the system may present the user with a web interface allowing for the intake of text and/or graphical updates. Thus, as an example, in a crowdfunded project whose goal is to develop and manufacture a circuit board, the entrepreneur may log into the disclosed system's website, access the corresponding venture profile, and include an update stating that “The Design Phase Of Our Project Is Complete.” The database server will then update the venture profile, and the system will transmit the update to the relevant crowdfunding platforms, where investors of the project will be notified of the update.

### Additional Features

### Valuation and Estimation

In another aspect of the present invention, the disclosed system offers several valuation and estimation services, which can be made available to computerized backend processes and to the users of the system through a website. In one embodiment, the system performs a financial valuation of the proposed venture. In another embodiment, the system analyzes a proposed venture and determines an optimal debt amount and conditions for the venture. In another embodiment, the system analyzes social media to determine the likelihood of the venture being successful at raising capital.

The system may perform financial valuation of a proposed venture based on a venture profile already stored in the database, or by requesting a user to provide parameters for his or her venture via the website. In performing the valuation, the system may rely on one method or a combination of several methods such as Discounted Cash Flow, Relative, and Contingent Claim valuation.

In applying Discounted Cash Flow valuation, the system analyzes financial data provided for the venture, such as revenue, expenses, year-to-year growth, and projections for future years. Based on these parameters, and optionally accounting for risk, the system may then generate an estimated valuation for the venture. In other circumstances, Relative Valuation is more appropriate than Discounted Cash Flow, such as, for example, early stage companies with negative cash flow.

In performing Relative Valuation, the system relies on data regarding similar companies and industries to value the venture. The system may rely on data stored in its database or access other industry databases for the data, such as industry indices. Thus, for example, the system may be asked to perform Relative Valuation for an early stage semiconductor company. The system would then access valuations of other companies in the semiconductor industry, and find the companies most similar to the proposed venture based on size, years in existence, and sales. The system can then base its Relative Valuation on similarly positioned companies in the same industry.

In performing Contingent Claim Valuation, the system valuates the proposed venture taking into account the significance of an uncertain event. Thus, for example, where the proposed venture is a pharmaceutical startup company, its valuation may greatly depend on the company's drug being approved by the U.S. Food and Drug Administration. In such circumstances, the system may account for a number of parameters in valuation, including, for example, the likelihood of the drug passing Phase 0, Phase 1, Phase 2, and Phase 3 trials. In the pharmaceutical scenario, other parameters may include the number of potential drug users, as well as the estimated price for the drug.

With respect to debt analysis, the system may determine the optimal loan amount to be borrowed by the venture. Depending on the circumstances, a certain amount of debt may actually increase the value of a company. The system would therefore, in one embodiment, determine the optimal loan amount, loan term, and other loan parameters, such as interest and repayment conditions, that would increase the valuation of the company based on accepted financial benchmarks.

Turning to social media analysis, the system may determine the likelihood of a proposed venture successfully raising the desired amount of capital based on data relating to a proposed venture's social media standing. The system determines a venture's social media standing by obtaining, for example, the number of a venture's followers on Twitter, its likes' on Facebook, and its Klout score. The system may also use factors such as the number of positive mentions on Twitter, Facebook, and other social media sites, to predict the likelihood of a venture succeeding in raising the desired capital. For example, a large number of positive mentions would increase the likelihood of success. In another embodiment, the system may continuously monitor and analyze social media feedback, to further refine success rate predictions based on social media indicators.

The outcome of financial valuation, debt analysis, and/or social media analysis can be used in different ways. In one embodiment, the system will present the outcome of its analysis to a user via the website. In another embodiment, the system will use the results of its analysis as part of its Match Engine to further refine acceptable platforms, for example, by incorporating the results into its query for appropriate crowdfunding platforms and processing of the venture profile. One of ordinary skill in the art would understand that a number of different valuation mechanisms are available for use in the disclosed system.

### Validation

In another aspect of the disclosed system, users, ventures, and crowdfunding platforms may be validated for authenticity, reliability, and other factors. Validation is an important service in the crowdfunding industry because government regulations frequently impose certain limits on crowdfunding activity. Further, investors are generally wary of fake monetary platforms that can cause a significant loss of capital.

In one embodiment, the system maintains a database of crowdfunding platforms that have been verified for authenticity and reliability. The verification may be performed on the business level, and/or on the network level. On the network level, the platforms may be required to periodically check in with the appropriate certificate or encryption key, to verify that the platform is up and running and has not been compromised. On the business level, the platforms may be verified for performance, government licenses, and other credentials. This information will then be stored on the system's database servers.

In another embodiment, the system maintains a database of investors, including their previous investments, locations, and amounts invested. Since certain government bodies cap the maximum amount a single investor can use to crowdfund ventures, the investor database will help keep investors, as well as crowdfunding platforms and posted ventures out of trouble by proactively forbidding investors from crossing the established investing threshold.

In another embodiment, the system maintains a database of ventures, including their previous funding rounds and amounts raised. The purpose of this database is to alert investors to previous funding requested and/or received by the venture. The data will also help keep unscrupulous entrepreneurs in check by publicly disclosing previous funding attempts. The data will also help verify financial information posted by entrepreneurs and startup companies in their venture profiles.

The database of ventures also helps startup companies keep within guidelines imposed by government regulatory bodies. Thus, if the law or regulations of a particular territory impose a maximum amount a company is allowed to raise on an equity based platform, the database of prior investments will greatly assist the company in complying with local laws. For example, in a territory where a company is allowed to raise up to $1,000,000 per year, if a company had two previous investment rounds within the past 12 months, the first raising $200,000, and the second raising $550,000, the system will record both funding rounds, and disallow any attempts to seek funding above the $250,000 remaining under the cap. The system may also notify interested crowdfunding platforms and/or government agencies of the disallowed funding attempts.

In the preferred embodiment, the database of ventures is also accessible via the system's website, where a user may search, browse, and filter through ventures available for investment, lending, and donation on various crowdfunding and investment platforms. The user may access the database of ventures similarly to the process described above with respect to the database of investment platforms. Venture profiles, which comprise the database of ventures, are described in FIG. 6 and accompanying text. In the preferred embodiment, once a user has found a suitable venture (by searching, filtering, or browsing through the ventures), the system provides a description of the venture and a portal for the user to access the venture on its crowdfunding website.

In certain configurations, the platform, investor, and venture validation databases may be kept open to the public, other crowdfunding organizations, or government agencies needing to access the validation data.

### Analytics and Marketing

In one embodiment, the disclosed system maintains records of end user activity, and stores it in a database on one or more of the database servers. The data can be used by the system administrator to adjust configuration parameters for a better user experience. In the preferred embodiment, the data may also be made available to users and crowdfunding platforms for a fee, including the names of the most frequently used and searched platforms, keywords, campaign types, and other data. Similarly, for a fee, the system may offer crowdfunding platforms an opportunity to reserve a higher placed, and/or highlighted, location on the results list of user searches.

### Online Platform

The system described herein is capable of maintaining records relating to hundreds and thousands of crowdfunding databases. Manually updating the records, such as the number of monthly visitors received by a platform, would be a daunting task. Therefore, in one embodiment, the disclosed system is capable of establishing a connection to crowdfunding platforms and receiving updates to its records from the platforms. The connections may be two-way, since the platforms may be interested in receiving certain data from the disclosed system, such as, for example, the venture profiles being pushed to multiple platforms.

### Other Platforms And Ventures

It will be understood by those of ordinary skill in the art that the inventions described herein are applicable to various types of investing platforms and ventures. Moreover, the term “investor” will be understood to include various types of financiers, including donors, lenders, and equity investors. In certain circumstances, such as where a product is being crowdfunded and the reward for funding the product is the ability to purchase the product itself, the investor in essence becomes a “buyer” of the product, even though he or she “invested” initial capital in the development and design of the product.

The foregoing description of the various and preferred embodiments of the present invention has been presented for purposes of illustration and explanation. It is not intended to be exhaustive nor to limit the invention to the specifically disclosed embodiments. The embodiments herein were chosen and described in order to explain the principles of the invention and its practical applications, thereby enabling others skilled in the art to understand and practice the invention. However, many modifications and variations will be apparent to those skilled in the art, and are intended to fall within the scope of the invention, claimed as follows.

What is claimed is:

1. A method for matching investment ventures with investment platforms, comprising:
receiving, over a computer network, information relating to an investment venture;
processing the received investment venture information;
storing the received investment venture information in computer storage; and
identifying appropriate investment platforms based on the received investment venture information.

2. The method of claim 1, further comprising:
accessing a database containing information relating to investment platforms;
querying the database based on a set of parameters obtained from the received investment venture information;
receiving a response from the investment platform information database; and
processing the response from the investment platform information database.

3. The method of claim 2, wherein the identifying appropriate investment platforms comprises:
determining a success rate of an investment venture for one or more investment platforms based on historical success rates of investment ventures having similar parameters.

4. The method of claim 2, wherein the identifying appropriate investment platforms comprises:
determining a success rate of an investment venture for one or more investment platforms based on social media indicators relating to the investment venture.

5. The method of claim 2, further comprising analyzing the received investment venture information to determine a valuation of the investment venture.

6. The method of claim 2, further comprising analyzing the received investment venture information to determine a substantially optimal debt amount for the investment venture.

7. The method of claim 1, wherein the investment venture is a business enterprise.

8. The method of claim 1, wherein the investment venture is a product manufacturing project.

9. The method of claim 1, further comprising:
identifying appropriate service offerings based on the received investment venture information; and
making available, over a computer network, access to the identified service offerings.

10. The method of claim 1, further comprising:
generating a venture profile based on information relating to an investment venture received over a computer network; and
transmitting the venture profile to one or more investment platforms over a computer network.

11. The method of claim 10, further comprising:
receiving, over a computer network, an update from a user regarding an investment venture; and
transmitting the update to one or more of the investment platforms to which the venture profile has been submitted over a computer network.

12. The method of claim 10, further comprising:
maintaining records, in a computer database, corresponding to the status of the investment venture.

13. The method of claim 10, further comprising:
receiving a response from the one or more investment platforms indicating that the venture profile has been accepted;
updating records in the computer database corresponding to the status of the investment venture.

14. A method for tracking investment venture information, comprising:
accessing, via a computer network, a computer server of an investment platform;
requesting information relating to an investment venture;
receiving a response from the investment platform's server;
processing the response received from the investment platform; and
storing data based on the received response in an investment venture database.

15. The method of claim 14, further comprising:
receiving a request, over a computer network, for information relating to an investment venture;
querying the investment venture database based on the received request;
receiving a response from the investment venture database;
processing the response from the investment venture database;
transmitting, over a computer network, information based on the response from the investment venture database to a user computer.

16. The method of claim 14, wherein the investment platform is a crowdfunding platform.

17. The method of claim 14, wherein the received response comprises the total amount of capital raised by the investment venture.

18. The method of claim 17, further comprising:
receiving a request to submit an investment venture profile to one or more investment platforms;
determining whether the total amount of capital raised by the investment venture exceeds a pre-set amount; and
denying the request to submit an investment venture profile to one or more investment platforms if the total amount of capital raised by the investment venture equals or exceeds the pre-set amount.

19. The method of claim 18, further comprising:
transmitting, over a computer network, to the one or more investment platforms (i) a notification that a request to submit an investment venture profile has been denied, and (ii) information relating to the investment venture profile.

20. The method of claim 14, further comprising:
maintaining records relating to investment activities by users;
tracking amounts of user investments in one or more investment platforms in comparison to a pre-determined investment limit; and
notifying a user, over a computer network, of the difference between the user's invested amount across the one or more investment platforms and the pre-determined investment limit.
